(19) United States
(12) Patent Application Publication
(10) Pub. No.: US 2013/0004875 A1
(43) Pub. Date: Jan. 3, 2013

(54) GAS-LIQUID SEPARATOR AND FUEL CELL SYSTEM HAVING THE SAME

(75) Inventors: Jung-Kurn PARK, Yongin-si (KR); Dong-Hyun KIM, Yongin-si (KR); Young-Seung NA, Yongin-si (KR)

(73) Assignee: SAMSUNG SDI CO., LTD., Yongin-si (KR)

(21) Appl. No.: 13/271,643

(22) Filed: Oct. 12, 2011

(30) Foreign Application Priority Data
Jun. 30, 2011 (KR) 10-2011-0065023

(51) Int. Cl. H01M 8/24; B01D 53/04

(52) U.S. Cl. 429/434; 96/131

(57) ABSTRACT

A gas-liquid separator including a housing, a first absorbing member, a second absorbing member, and a liquid pump is disclosed. The housing may include an inflow port, a gas outlet port, and a liquid outlet port. The first absorbing member may be disposed contacting the liquid outlet port in an inner space of the housing. The first absorbing member may be configured to absorb liquid in a gas-liquid mixture received from the inlet port. The second absorbing member may be disposed apart from the first absorbing member in the inner space of the housing. The second absorbing member may have a smaller volume than the absorbing member. The liquid pump may be in fluid communication with the liquid outlet port and be configured to discharge liquid absorbed by the first absorbing member

### CROSS-REFERENCE TO RELATED APPLICATIONS

This application claims priority to and the benefit of Korean Patent Application No. 10-2011-0065023 filed in the Korean Intellectual Property Office on Jun. 30, 2011, the entire contents of which are incorporated herein by reference.

### BACKGROUND

1. Field

The technology relates generally to a gas-liquid separator and a fuel cell system having the same.

2. Description of the Related Technology

A fuel cell system includes a fuel cell stack, which generates electrical energy by an electrochemical reaction between a fuel (hydrocarbon fuel, hydrogen gas, or reformed gas rich in hydrogen) and an oxidant (air or oxygen). Among various types of fuel cells, a direct methanol fuel cell (DMFC) directly supplies methanol to an anode of a fuel cell stack to generate electrical energy by a reaction between methanol and oxygen supplied to a cathode of the fuel cell stack. In a DMFC-type fuel cell system, high-concentration methanol fuel is stored in a cartridge or a fuel tank and transferred to a mixer by a fuel pump. The methanol transferred to the mixer is then mixed with water and diluted to “low-concentration” of between about 0.5 M and 2 M. The low-concentration methanol is supplied to the anode of the fuel cell stack through a supply pump. In the electrical energy generation process, unreacted fuel containing carbon dioxide is discharged from the anode of the fuel cell stack and unreacted air is discharged from the cathode. A gas-liquid mixture discharged from the fuel cell stack is separated into liquid and gas through a gas-liquid separator and a heat exchanger, and the separated liquid is supplied to the anode of the fuel cell stack and reused.

For application of the above-stated fuel cell system to various mobile devices, the gas-liquid separator should be smoothly operated without regard to a direction of gravity when considering movements of an activated mobile device. In addition, the volume of the entire fuel cell system needs to be reduced for portability; the gas-liquid separator and the heat exchanger should be down-sized by increasing liquid recovery efficiency with respect to a gas-liquid mixture discharged from the fuel cell system.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

In one aspect, a gas-liquid separator is provided that can be easily applied to a mobile device by performing smooth gas-liquid separation without regard to a direction of the gravity, and a fuel cell system having the same.

In another aspect, a gas-liquid separator is provided that can be reduced in volume by improving liquid recovery efficiency with respect to a gas-liquid mixture discharged from a fuel cell stack, and a fuel cell system having the same.

In another aspect, a gas-liquid separator is provided. The gas-liquid separator includes, for example, a housing including an inflow port configured to receive a gas-liquid mixture, a gas outlet port, and a liquid outlet port, a first absorbing member disposed to contact the liquid outlet port in an inner space of the housing and configured to absorb liquid in the gas-liquid mixture, a second absorbing member disposed in the inner space of the housing, the second absorbing member having a smaller volume than a volume of the first absorbing member, the second absorbing member not contacting the first absorbing member, a liquid pump in fluid communication with the liquid outlet port, and a gas flow path fluidly connecting the inlet port and the gas outlet port, the gas flow path formed between at least a part of the first absorbing member and at least a part of the second absorbing member.

In some embodiments, the first absorbing member and the second absorbing member are formed of a hydrophilic and porous material. In some embodiments, the gas flow path is directed toward the second absorbing member from the center of the housing. In some embodiments, the first absorbing member and the second absorbing member have the same thickness. In some embodiments, the size of the second absorbing member is about 0.01 to about 0.25 times the size of the first absorbing member. In some embodiments, the second absorbing member is formed with a constant width along an inner side of the housing. In some embodiments, the second absorbing member partially contacts the inner side of the housing. In some embodiments, the width of the second absorbing member is about 1 mm to about 5 mm.

In some embodiments, the gas-liquid separator further includes an auxiliary absorbing member contacting both the first absorbing member and the second absorbing member in the housing. In some embodiments, the auxiliary absorbing member has a thickness smaller than that of each of the first and second absorbing members. In some embodiments, the housing includes a pair of first side walls facing each other, and a pair of second side walls perpendicular to the pair of first side walls and shorter than the pair of first side walls in length. In some embodiments, the inflow port is formed in one of the pair of second side walls and the liquid outlet port is formed in one of the pair of first side walls. In some embodiments, the gas outlet port is formed at a first distance from the inlet port in the second side wall where the inlet port is formed. In some embodiments, the first absorbing member is formed at a second distance from the entire second side wall where the inlet port is formed. In some embodiments, the second absorbing member is formed in parallel with the second side wall. In some embodiments, the inlet port is formed partially contacting the same.

In some embodiments, the gas outlet port is formed in the other one of the pair of first side walls. In some embodiments, the first absorbing member is disposed at a third distance from the entire second side wall where the inlet portion is formed and a part of the first side wall where the gas outlet port is formed. In some embodiments, the second absorbing member is formed in parallel with the second side wall where the inlet port is formed while partially contacting the same. In some embodiments, the gas outlet port is formed in the other one of the pair of first side walls. In some embodiments, the first absorbing member is disposed at a fourth distance from the entire second side wall where the inlet port is formed and the entire first side wall where the gas outlet port is formed. In some embodiments, the second absorbing member is formed in parallel with the first side wall where the gas outlet port is formed while partially contacting an inner side of the first side wall.

In some embodiments, the gas-liquid separator further includes a barrier wall provided at a side of the first absorbing member facing the second side wall where the inlet port is formed. In some embodiments, the gas outlet port is formed in the other one of the pair of second side walls. In some embodiments, the first absorbing member is disposed at a fifth distance from the entire second side wall where the inlet port is formed, the other first side wall. In some embodiments, a part of the second side wall where the gas outlet port is formed. In some embodiments, the second absorbing member is formed in parallel with the other first side wall while contacting the first side wall. In some embodiments, the gas-liquid separator further includes, for example, a barrier wall provided at a side of the first absorbing member and facing the second side wall where the inlet port is formed.

In another aspect, a fuel cell system includes, for example, a fuel cell stack configured for generating electrical energy by a reaction between an oxidant and a fuel and discharging a first gas-liquid mixture, a first gas-liquid separator configured to receive the first gas-liquid mixture from the fuel cell stack and configured to separate the first gas-liquid mixture into a gas and a liquid, a first heat exchanger configured to receive the gas from the first gas-liquid separator and configured to discharge a second gas-liquid mixture having a temperature lower than that of the first gas-liquid mixture by cooling the gas, and a second gas-liquid separator configured to receive the second gas-liquid mixture from the first heat exchanger, configured to separate the second gas-liquid mixture into gas and liquid, and configured to supply the separated liquid to the first gas-liquid separator.

In some embodiments, the fuel cell system further includes a mixer in fluid communication with the first gas-liquid separator, the mixer configured to dilute a fuel using the liquid supplied from the first gas-liquid separator and configured to supply the diluted fuel to the fuel cell stack, and a second heat exchanger in fluid communication with the mixer and the fuel cell stack, the second heat exchanger configured to decrease a temperature of the fuel supplied to the fuel cell stack.

In some embodiments, the second gas-liquid separator includes, for example, a housing including an inflow port configured to receive a gas-liquid mixture, a gas outlet port, and a liquid outlet port; a first absorbing member disposed in an inner space of the housing, the first absorbing member positioned to contact the liquid outlet port and configured to absorb liquid in the gas-liquid mixture received from the inlet port; a second absorbing member disposed separate from the first absorbing member in the inner space of the housing, the second absorbing member having a smaller volume than a volume of the first absorbing member; a liquid pump in fluid communication with the liquid outlet port; and a gas flow path formed between the first absorbing member and the second absorbing member, the gas flow path fluidly connecting the inlet port and the gas outlet port.

In some embodiments, the first absorbing member and the second absorbing member are formed of a hydrophilic and porous material. In some embodiments, the gas flow path is directed toward the second absorbing member from the center of the housing. In some embodiments, the first absorbing member and the second absorbing member have the same thickness. In some embodiments, the size of the second absorbing member is about 0.01 to about 0.25 times the size of the first absorbing member.

In another aspect, a gas-liquid separator is provides that does not use a hydrophilic material. In some embodiments, no pressure-loss occurs and a liquid leakage to the gas outlet port may be suppressed to thereby improve liquid recovery efficiency. In some embodiments, water absorbed to a first absorbing member is compulsively discharged using a liquid pump thereby realizing excellent gas-liquid separation performance without regard to a direction of gravity. In some embodiments, a fuel cell system is provided with a down-sized heat exchanger and gas-liquid separator by increasing liquid recovery efficiency.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is an exploded perspective view of a gas-liquid separator according to a first exemplary embodiment.

FIG. 2 is a top plan view of portions of the gas-liquid separator of FIG. 1, excluding a covering unit.

FIG. 3 is a cross-sectional view of a gas-liquid separator according to the first exemplary embodiment.

FIG. 4 is a top plan view of portions of a gas-liquid separator, excluding a covering unit according to a second exemplary embodiment.

FIG. 5 is a top plan view of portions of a gas-liquid separator, excluding a covering unit according to a third exemplary embodiment.

FIG. 6 is a top plan view of portions of a gas-liquid separator, excluding a covering unit according to a fourth exemplary embodiment.

FIG. 7 is a schematic diagram of a fuel cell system according to an exemplary embodiment.

FIG. 8 is an exploded perspective view of a structure of a fuel cell stack of FIG. 7.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. Further, in the embodiments, like reference numerals designate like elements throughout the specification representatively in a first embodiment, and only elements of embodiments other than those of the first embodiment will be described. The drawings and description are to be regarded as illustrative in nature and not restrictive. However, it should be understood that the disclosure is not limited to a specific embodiment but includes all changes and equivalent arrangements and substitutions included in the spirit and scope of the disclosure. Descriptions of unnecessary parts or elements may be omitted for clarity and conciseness, and like reference numerals refer to like elements throughout. In the drawings, the size and thickness of layers and regions may be exaggerated for clarity and convenience.

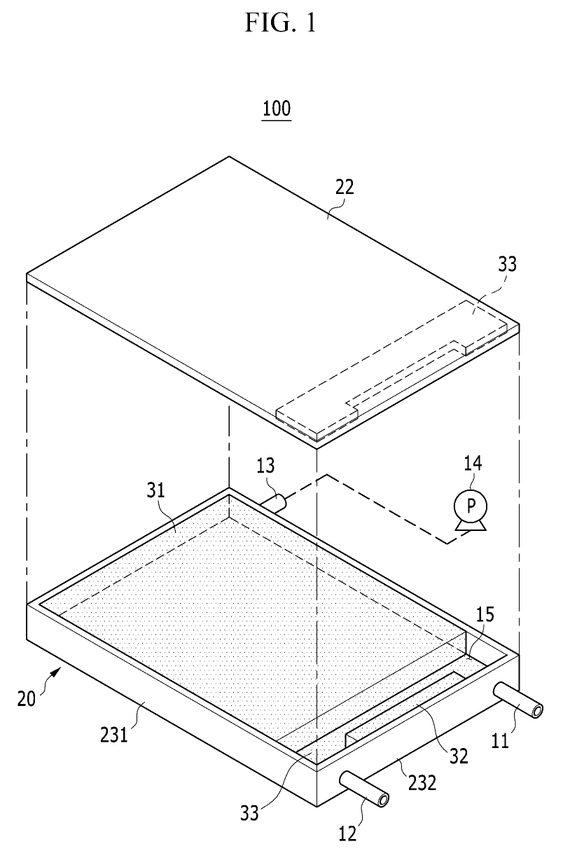

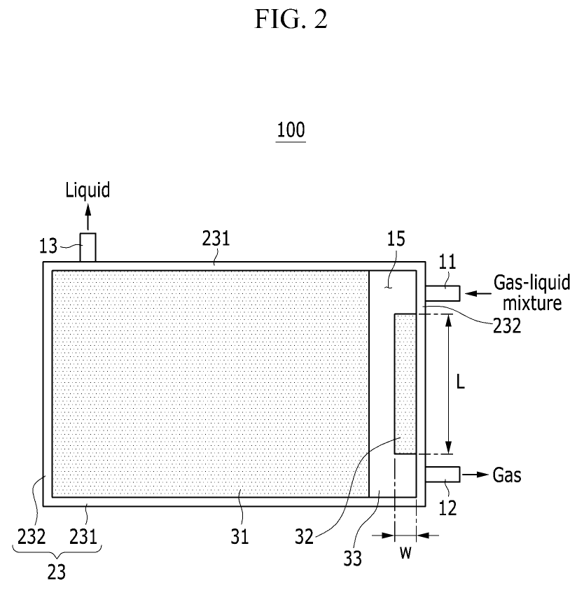

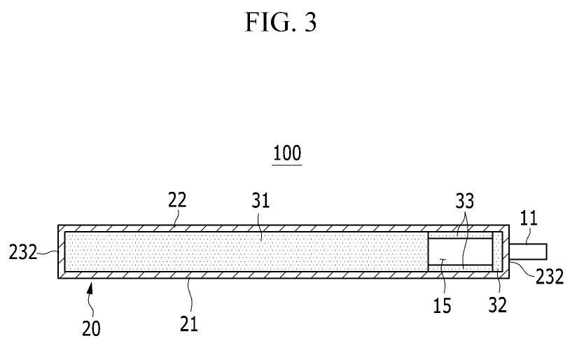

FIG. 1 is an exploded perspective view of a gas-liquid separator according to a first exemplary embodiment, FIG. 2 is a top plan view of the gas-liquid separator of FIG. 1, excluding a cover portion, and FIG. 3 is a cross-sectional view of the gas-liquid separator according to the first exemplary embodiment. Referring to FIG. 1 to FIG. 3, a gas-liquid separator 100 includes a housing 20 including an inflow port 11, a gas outlet portion 12, and a liquid outlet portion 13, first and second absorbing members 31 and 32 formed in an inner space of the housing 20, and a liquid pump 14 in fluid communication with the liquid outlet portion 13. The first absorbing member 31 contacts the liquid outlet portion 13 and the second absorbing member 32 is spaced apart from the first absorbing member 31. In addition, a gas flow path 15 that fluidly connects the inflow port 11 and the gas outlet portion 12 is formed between the first absorbing member 31 and the second absorbing member 32.

The housing 20 includes a bottom portion 21, a cover portion 22, and a side wall 23 connecting the bottom portion 21 and the cover portion 22. The side wall 23 may be disposed in various shapes, and for example, may be disposed in a rectangular shape. In this case, the housing 20 includes a pair of first side walls 231 facing each other and a pair of second side walls 232 facing each other. The pair of first side walls 231 and the pair of second side walls 232 are respectively perpendicular to each other, and the length of the second side wall 232 is smaller than that of the first side wall 231. The shape of the housing 20 is not limited to the shape illustrated in the drawing, and it may be variously modified.

The inflow port 11 may be formed in one of the pair of second side walls 232 and the liquid outlet portion 13 may be formed in one of the pair of first side walls 231. The gas outlet portion 12 may be formed in the second side wall 232 where the inflow port 11 is formed. In this case, the inflow port 11 is disposed at one edge of the second side wall 232 and the gas outlet portion 12 is disposed at the other edge of the second side wall 232.

The first absorbing member 31 contacts the liquid outlet portion 13, and is disposed at a predetermined distance from the second side wall 232 where the inflow port 11 and the gas outlet portion 12 are disposed. The first absorbing member 31 has a thickness the same as the height of the side wall 23, thereby filling a part of the inner space of the housing 20. The first absorbing member 31 partially contacts the pair of first side walls 231 and may wholly contact the other second side wall 232 where the inflow port 11 and the gas outlet portion 12 are not disposed.

The second absorbing member 32 may be disposed in parallel with the second side wall 232 where the inflow port 11 and the gas outlet portion 12 are disposed, while contacting the same. The second absorbing member 32 is configured to maintain predetermined distances with respect to the first absorbing member 31, the inflow port 11, and the gas outlet portion 12. Accordingly, the gas flow path 15 fluidly connecting the inflow port 11 and the gas outlet portion 12 may be formed between the first absorbing member 31 and the second absorbing member 32. The thickness of the second absorbing member 32 may be the same as the height of the side wall 23. The second absorbing member 32 has a length L (refer to FIG. 2) smaller than the distance between the inflow port 11 and the gas outlet portion 12, and has a width W (refer to FIG. 2) configured to prevent the gas flow path 15 from being lengthened within the housing 20.

The first absorbing member 31 and the second absorbing member 32 may be formed of a hydrophilic material with excellent wettability and that does not cause pressure loss. The first absorbing member 31 and the second absorbing member 32 may be formed of a porous material with a plurality of pores. Thus, the first absorbing member 31 and the second absorbing member 32 may be configured to easily absorb a liquid component from the gas-liquid mixture. Liquid absorbed by the first absorbing member 31 may be discharged to the outside of the housing 20 by a pumping force of the liquid pump 14 and then supplied to a fuel cell stack (not shown) for reuse.

The liquid outlet portion 13 may be disposed at one edge of the first side wall 231 apart from the inflow port 11. In this case, a liquid flow path is aligned along the first absorbing member 31, and thus, in operation the liquid may be absorbed along the liquid flow path by the entire first absorbing member 31. Accordingly, use efficiency and liquid absorption capability of the first absorbing member 31 can be improved.

Auxiliary absorbing members 33 may be respectively formed in one side of the bottom portion 21 and one side of the cover portion 22 that face the gas flow path 15.

The auxiliary absorbing members 33 are formed with a thickness that is smaller than those of the first absorbing member 31 and the second absorbing member 32 so as to be disposed at a distance from each other along a thickness direction (the vertical direction of FIG. 3) of the housing 20. The auxiliary absorbing members 33 are formed of a hydrophilic and porous material, like the first absorbing member 31 and the second absorbing member 32.

The auxiliary absorbing members 33 may be positioned to contact the first absorbing member 31 and the second absorbing member 32 and thus connect the first absorbing member 31 with the second absorbing member 32. Thus, a portion of the liquid absorbed by the second absorbing member 32 may pass through the auxiliary absorbing members 33 and then transfer to the first absorbing member 31.

Although the auxiliary absorbing members 33 are illustrated as being respectively formed in one side of the bottom portion 21 and one side of the cover portion 22 that face the gas flow path 15 in FIG. 1 to FIG. 3, the auxiliary absorbing member 33 may be additionally formed in at least one of a portion in the second side wall 232 where the second absorbing member 32 is not disposed and a portion in the first side wall 231 where the first absorbing member 31 is not disposed.

As described, the gas flow path 15 in the housing 20 may be surrounded by the first absorbing member 31, the second absorbing member 32, and the auxiliary absorbing members 33. If the second absorbing member 32 and the auxiliary absorbing member 33 are not provided, an inner surface of the housing 20 formed of metal or plastic may be exposed. In this case, residual liquid of the gas-liquid mixture that flows in through the inflow port 11, that is not absorbed by the first absorbing member 31 may flow along the inner surface of the housing 2 and thus is discharged through the gas outlet portion 12 to the outside.

In operation, the inner space of the housing 20 is configured to flow the gas-liquid mixture through the inflow port 11 along the gas flow path 15. During this process, the liquid component of the gas-liquid mixture may be absorbed by the first absorbing member 31 and then the absorbed liquid may be discharged to the outside of the housing 20 by the pumping force of the liquid pump 14. Other gas components may be discharged through the gas outlet portion 12 to the outside.

The second absorbing member 32 is positioned and spaced apart from the first absorbing member 31 and may not contact the liquid outlet portion. Thus, in operation, the liquid absorbed by the second absorbing member 32 cannot be reused in the above gas-liquid separation process. Although the second absorbing member 32 is connected with the first absorbing member 31 by the auxiliary absorbing member 33, the amount of liquid that transfers through the auxiliary absorbing member 33 during operation of the device may not be significant since the auxiliary absorbing member 33 may have a relatively small thickness. Thus, the second absorbing member 32 may be formed in the smallest size possible such that it may be configured to suppress flow of residual liquid that is not absorbed by the first absorbing member 31 along the inner surface of the housing 20. That is, the second absorbing member 32 is smaller than the first absorbing member 31 in volume. During operation of the device, when the second absorbing member 32 is larger than the first absorbing member 31 in volume the second absorbing member 32 may absorb more liquid than the first absorbing member 31. The liquid absorbed by the second absorbing member 32 may then be directed to a certain direction due to gravity. Further, when the gas outlet portion 12 faces the ground, the liquid of the second absorbing member 32 may be discharged through the gas outlet portion 12 to the outside. Additionally, when the inflow port 11 faces the ground, the performance of the gas-liquid separator 100 may be significantly deteriorated.

When the first absorbing member 31 and the second absorbing member 32 have a same thickness, the second absorbing member 32 may be about 0.01 to about 0.25 times larger than the first absorbing member 31. When the second absorbing member 32 is smaller than about 0.01 times of the size of the first absorbing member 31, the liquid absorption capability of the second absorbing member 32 is deteriorated; liquid that cannot be absorbed by the first and second absorbing members 31 and 32 may be discharged through the gas outlet portion 12 to the outside. When the second absorbing member 32 is larger than about 0.25 times of the size of the first absorbing member 31, the liquid absorbed by the second absorbing member 32 may be directed due to gravity and thus the liquid may be discharged through the gas outlet portion 12 to the outside or the overall performance of the gas-liquid separator 100 may be deteriorated.

In addition, as the size of the second absorbing member 32 is increased, the gas flow path 15 becomes a path surrounding the second absorbing member 32, which thus lengthens the gas flow path 15. In this case, the amount of air that permeates into the second absorbing member 32 increases and the air pushes away the water absorbed by the second absorbing member 32 so that liquid leakage toward the gas outlet portion 12 is accelerated.

Thus, the second absorbing member 32 may be formed with a width equal to or less than about 5 mm along an inner side of the second side wall 232. In this configuration, the gas flow path 15 may be disposed closer to the second absorbing member 32 with reference to the center of the housing 20. That is, the gas flow path 15 may be disposed toward the second absorbing member 32 rather than crossing the center of the housing 20 so that the length thereof can be minimized.

The width W (refer to FIG. 2) of the second absorbing member 32 may be about 1 mm to about 5 mm. When the width W of the second absorbing member 32 is less than about 1 mm, liquid holding capability of the second absorbing member 32 may be deteriorated and liquid that cannot be absorbed by the first and second absorbing members 31 and 32 may be discharged through the gas outlet portion 12 to the outside. When the width W of the second absorbing member 32 is larger than about 5 mm, the liquid absorbed to the second absorbing member 32 may be directed due to gravity so that the liquid may be discharged through the gas outlet portion 12 to the outside or the performance of the gas-liquid separator 100 may be deteriorated.

As described, in the gas-liquid separator 100 of the first exemplary embodiment, the first absorbing member 31 contacts the liquid outlet portion 13, and the second absorbing member 32 spaced apart from the first absorbing member 31 has a uniform width and a small volume. Thus, the gas flow path 15 is disposed toward the second absorbing member 32 rather than crossing the center of the housing 20 so that the gas flow path 15 has the shortest path possible.

Unlike a conventional gas-liquid separator, the gas-liquid separator 100 according to the first exemplary embodiment does not use a hydrophobic material, and therefore pressure loss due to the hydrophobic material does not occur. In addition, the first absorbing member 31 formed of the hydrophilic and porous material contains a sufficient amount of liquid and continuously discharges the liquid to the outside using the liquid pump 14, thereby realizing an unexpectedly superior gas-liquid separation performance.

Further, since the liquid discharge of the first absorbing member 31 is artificially performed using the liquid pump 14 rather than by gravity, the gas-liquid separator 100 can provide a high gas-liquid separation performance even in a situation in which the gas-liquid separator is disposed upright or turned upside down. That is, the gas-liquid separator 100 can maintain a high gas-liquid separation performance regardless of the direction of gravity, and therefore the gas-liquid separator 100 may thus be more suitable for a mobile device.

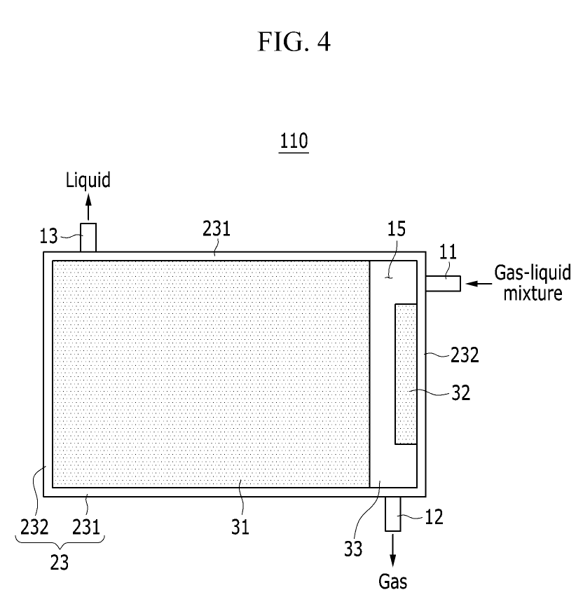

FIG. 4 is a top plan view of a gas-liquid separator, excluding a cover portion, according to a second exemplary embodiment. Referring to FIG. 4, in a gas-liquid separator 110, an inflow port 11 is disposed at one of a pair of second side walls 232 and a liquid outlet portion 13 is disposed at one of a pair of first side walls 231. A gas outlet portion 12 is disposed in the other one of the pair of the first side walls 231. The gas outlet portion 12 is disposed at one edge of the first side wall 231, neighboring the second side wall 232 where the inflow port 11 is formed. Other configurations, except for the location of the gas outlet portion 12 may be the same as or similar to that of the first exemplary embodiment, and like reference numerals designate like elements as those of the first exemplary embodiment.

In the gas-liquid separators 100 and 110 of the first and second exemplary embodiments, respectively, the gas flow path 15 is formed in parallel to and inside of the second side wall 232 where the inflow port 11 is disposed. In this case, the second side wall 232 is shorter than the first side wall 231 so that the gas flow path 15 has the shortest path possible in the housing 20.

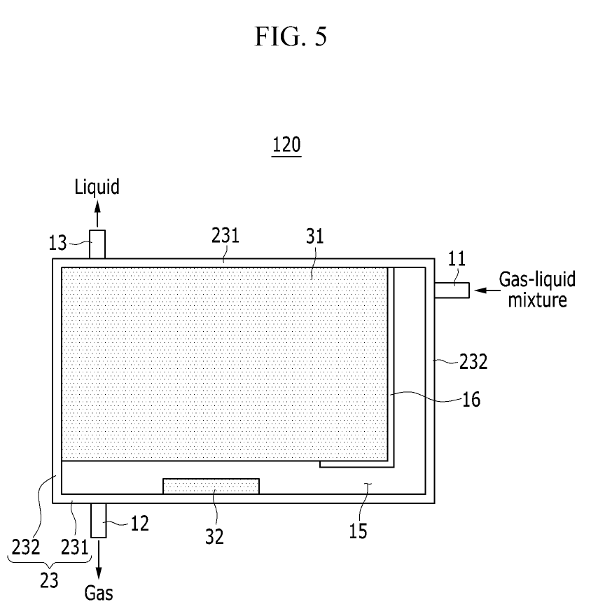

FIG. 5 is a top plan view of a gas-liquid separator, excluding a cover portion, according to a third exemplary embodiment. Referring to FIG. 5, in a gas-liquid separator 120, an inflow port 11 is disposed at one of a pair of second side walls 232 and a liquid outlet portion 13 is disposed at one of a pair of first side walls 231. A gas outlet portion 12 is disposed at the other one of the pair of first side walls 231. The gas outlet portion 12 is disposed at one edge of the first side wall 231, neighboring a second side wall 232 where the inflow port 11 is not disposed. The first absorbing member 31 is spaced apart from the entire second side wall 232 where the inflow port 11 is disposed and from the entire first side wall 231 where the gas outlet portion 12 is disposed.

In the gas-liquid separator 120 of the third exemplary embodiment, a gas flow path 15 is formed in parallel to the second side wall 232 and the first side wall 231 at inner sides of the first side wall 231 where the gas outlet portion 12 is disposed and the second side wall 232 where the inflow port 11 is disposed. That is, the gas flow path 15 is in parallel to and inside of the two side walls 231 and 232 among the four side walls 23.

A barrier wall 16 may be disposed at a side of the first absorbing member 31 facing the second side wall 232 where the inflow port 11 is disposed. The barrier wall 16 reduces the area where the first absorbing member 31 contacts a gas. The barrier wall 16 may also be disposed at a part of a side of the first absorbing member 31 facing the first side wall 231 where the gas outlet portion 12 is disposed. The second absorbing member 32 is disposed in parallel to the first side wall 231 while contacting a part of the first side wall 231 where the gas outlet portion 12 is disposed.

The configuration of the gas-liquid separator 120 is the same as that of the second exemplary embodiment, except for the locations of the gas outlet portion 12, the second absorbing member 32, and the shape of the first absorbing member 31, and like reference numerals designate like elements as those of the second exemplary embodiment.

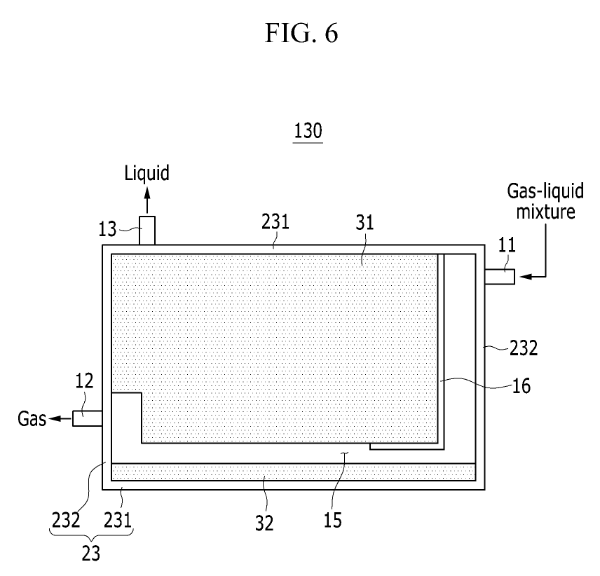

FIG. 6 is a top plan view of a gas-liquid separator, excluding a cover portion, according to a fourth exemplary embodiment. Referring to FIG. 6, in a gas-liquid separator 130, an inflow port 11 is disposed at one of a pair of second side walls 232 and a liquid outlet portion 13 is disposed at one of a pair of first side walls 231. A gas outlet portion 12 is disposed at the other one of the pair of second side walls 232. The first absorbing member 31 is disposed at a distance from the entire second side wall 232 where the inflow port 11 is disposed, from the entire first side wall 231 where the liquid outlet portion 13 is not disposed, and from a part of the second side wall 232 where the gas outlet portion 12 is disposed.

In the gas-liquid separator 130 of the fourth exemplary embodiment, a gas flow path 15 is formed in parallel to the entire second side wall 232 where inflow port 11 is disposed, to the entire first side wall 231 where the liquid outlet portion 13 is not disposed, and to a part of the second side wall 232 where the gas outlet portion 12 is disposed.

A barrier wall 16 may be disposed at a side of a first absorbing member 31 facing the second side wall 232 where the inflow port 11 is disposed. The barrier wall 16 may be positioned or configured to reduce the surface area where the first absorbing member 31 contacts a gas. The barrier wall 16 may be disposed at a part of a side of a first absorbing member 31 facing the first side wall 231 where the liquid outlet portion 13 is not disposed. A second absorbing member 32 is disposed in parallel to the first side wall 231 while contacting the entire first side wall 231 where the liquid outlet portion 13 is not disposed.

The configuration of the gas-liquid separator 130 is the same as that of the third exemplary embodiment, except for the location of the gas outlet portion 12 and the shape of the first and second absorbing members 31 and 32, and like reference numerals designate like elements as those of the second exemplary embodiment.

The gas-liquid separators 100, 110, 120, and 130 according to the first to fourth exemplary embodiments may be used as a second gas-liquid separator in a fuel cell system to be described hereinafter.

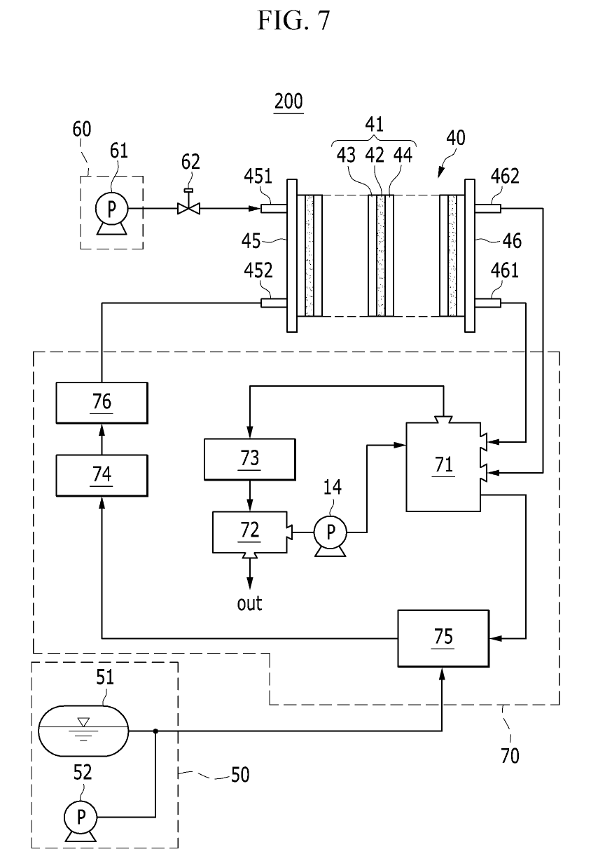

FIG. 7 is a schematic diagram of a fuel cell system according to another exemplary embodiment. Referring to FIG. 7, a fuel cell system 200 may adopt a direct methanol fuel cell (DMFC) that generates electrical energy using an electrochemical reaction of methanol and oxygen. However, the present disclosure is not limited thereto, and the fuel cell system 200 may adopt a direct oxidation fuel cell (DOFC) that makes a liquid or gas fuel including hydrogen such as ethanol, liquefied petroleum gas (LPG), liquefied natural gas (LNG), gasoline, butane gas, and the like react with oxygen. Further, the fuel cell system 200 may adopt a polymer electrolyte membrane fuel cell (PEMFC) using a hydrogen-rich reformed gas as a fuel.

The fuel cell system 200 includes a fuel cell stack 40 configured to generate electrical energy using a fuel and an oxidant, a fuel supply 50 configured to supply a fuel to the fuel cell stack 40, an oxidant supply 60 configured to supply an oxidant to the fuel cell stack 40, and a recovery unit 70 configured to recover liquid among a first gas-liquid mixture discharged from the fuel cell stack 40 and configured to re-supply the liquid to the fuel cell stack 40.

The fuel supply 50 and the oxidant supply 60 are respectively fluidly connected to the fuel cell stack 40. The oxidant supply 60 may be directly fluidly connected to the fuel cell stack 40, and the fuel supply 50 may be fluidly connected to the fuel cell stack 40 through the recovery unit 70. The fuel supply 50 includes a fuel tank 51 (or, a cartridge) configured for storing a liquid fuel and a fuel pump 52. The fuel pump 52 is configured to discharge the liquid fuel stored in the fuel tank 51 with a predetermined pumping force and configured to supply the same to the fuel cell stack 40. As a high-concentrated fuel, the fuel stored in the fuel tank 51 may be high-concentrated methanol.

The oxidant supply 60 includes an oxidant pump 61 configured to supply external air to the fuel cell stack 40 with a predetermined pumping force. A control valve 62 is positioned and configured to control a supply amount of the oxidant, which may be provided between the fuel cell stack 40 and the oxidant supply 60.

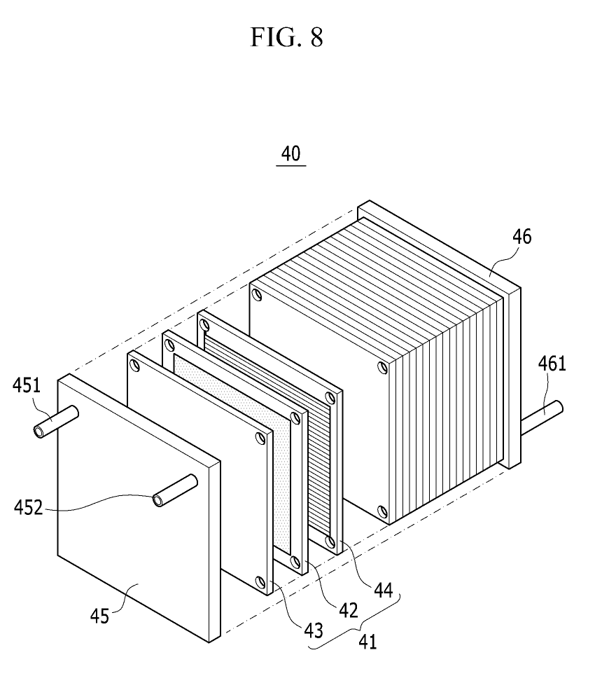

FIG. 8 is an exploded perspective view of a structure of the fuel cell stack of FIG. 7. Referring to FIG. 7 and FIG. 8, the fuel cell stack 40 is provided with a plurality of electrical energy generators 41 configured to generate electrical energy by inducing an oxidation/reduction reaction between the fuel and the oxidant. Each electrical energy generator 41 may include a unit cell generating electricity. Each electrical energy generator 41 includes a membrane electrode assembly (MEA) 32 configured to generate an oxidation/reduction reaction between the fuel and the oxidant and separators 43 and 44 (also referred to as bipolar plates) configured to supply the fuel and the oxidant to the MEA 42. The electrical energy generator 41 has a structure in which a pair of separators 43 and 44 disposed at respective sides of the MEA 42; the MEA 42 is sandwiched between the pair of separators 43 and 44. The MEA 42 includes an electrolyte membrane disposed at a center thereof, a cathode disposed at one side of the electrolyte membrane, and an anode disposed at the other side of the electrolyte membrane. The separators 43 and 44 are disposed close to the MEA 42 to form a fuel path and an air path at both sides of the MEA 42. In this case, the fuel path is disposed in the anode of the MEA 42 and the air path is disposed in the cathode of the MEA 42.

During operation of the fuel cell, in the anode, hydrogen in the fuel is decomposed to electrons and protons by the oxidation reaction of the fuel. The protons move to the cathode through the electrolyte membrane. In addition, electrons move to the neighboring MEA 42 through the separator 43, and in this case, a current is generated due to the flow of the electrons. The protons supplied from the cathode and oxygen generate moisture through a reduction reaction therebtween.

A pair of end plates 45 and 46 are disposed at the outermost of the fuel cell stack 40 to integrally fix plurality of electrical energy generators 41. In one end plate 45, a first inlet 451 is formed and configured for receiving the oxidant and a second inlet 452 is formed and configured for receiving the fuel are formed. In the other end plate 46, a first outlet 461 is formed and configured for discharging unreacted air containing moisture and a second outlet 462 is formed and configured for discharging an unreacted fuel and other substances (for example, carbon dioxide) are formed.

The recovery unit 70 is fluidly connected with the first and second outlets 461 and 462 and is configured to receive a first gas-liquid mixture discharged from the fuel cell stack 40. The recovery unit 70 includes two gas-liquid separators 71 and 72, two heat exchangers 73 and 74, and one mixer 75 for improvement liquid recovery efficiency with respect to a first gas-liquid mixture. In this case, the two gas-liquid separators 71 and 72 are formed of “directionless” separators that are configured to perform gas-liquid separation without regard to a direction of the gravity. The first gas-liquid separator 71 is directly and fluidly connected with the first and second outlets 461 and 462 of the fuel cell stack 40 to receive unreacted air containing moisture from the first outlet 461 and configured to receive an unreacted fuel containing carbon dioxide from the second outlet 462. The first gas-liquid separator 71 may be formed of a centrifugation-type separator. The centrifugation-type first gas-liquid separator 71 includes a rotor (not shown) rotatably provided in a case (not shown) and a motor (not shown) rotating the rotor. When the rotor rotates by the motor, a centrifugal force may be generated in the case and the first gas-liquid mixture may be separated into gas and liquid components by the centrifugal force.

Since the first gas-liquid separator 71 is operated not by a gravity method or by a membrane method, but instead by a centrifugation method, uniform gas-liquid separation performance can be realized. That is, when the case experiences a position change (for example, being stood up or turned upside down), the performance of the first gas-liquid separator 71 is not changed.

In operation, the first gas-liquid separator 71 discharges gas, which flows to the first heat exchanger 73, and then the separated liquid flows to the mixer 75. The first heat exchanger 73 partially condenses the received gas by cooling the gas. The unreacted fuel and moisture discharged from the fuel cell stack 40 have a temperature higher than about 60° C., and therefore the gas can be partially condensed into liquid by decreasing the temperature of the gas in the first heat exchanger 73. A second gas-liquid mixture discharged from the first heat exchanger 73 flows to the second gas-liquid separator 72. A temperature of the second gas-liquid mixture is lower than that of the first gas-liquid mixture. The second gas-liquid separator 72 is formed of one of the gas-liquid separators 100, 110, 120, and 130 of the first to fourth exemplary embodiments shown in FIG. 1 to FIG. 6. The second gas-liquid separator 72 is fluidly connected with the first gas-liquid separator 71, and a liquid pump 14 is provided between the second gas-liquid separator 72 and the first gas-liquid separator 71.

The second gas-liquid separator 72 is configured to separate the received second gas-liquid mixture into liquid and gas. In operation, the gas separated from the second gas-liquid separator 72 is discharged to the outside and the liquid is supplied to the first gas-liquid separator 71 by a pumping force of the liquid pump 14. As the liquid discharged from the second gas-liquid separator 72 is entered into the first gas-liquid separator 71 again, the gas-liquid mixture discharged from the fuel cell stack 40 experiences the gas-liquid separation process three times. Accordingly, the recovery unit 70 may be configured to improve liquid recovery efficiency.

Further, in operation, the liquid discharged from the first gas-liquid separator 71 may flow into the mixer 75. In this case, the liquid exists in the state be a mixture of an unreacted fuel and moisture. Further, the mixer 75 is connected with the fuel supply 50. Thus, high-concentrated fuel transmitted from the fuel supply 50 flows into the mixer 75, and the high-concentrated fuel is mixed with moisture in the mixer 75 and thus diluted to low-concentration of about 0.5 M to about 2 M. The fuel diluted to low-concentration in the mixer 75 is transmitted to the second heat exchanger 74, and the second heat exchanger 74 decreases a temperature of the received fuel and supplies the temperature-decreased fuel to the second inlet 452 of the fuel cell stack 40. A concentration sensor 76 that senses fuel concentration may be provided between the second heat exchanger 74 and the fuel cell stack 40.

The fuel cell system 200 according to the present exemplary embodiment may be configured to separate liquid using the first gas-liquid separator 71 and cool gas separated by the first gas-liquid separator 71 in the first heat exchanger 73 so that gasification of the fuel due to a temperature difference between unreacted fuel and unreacted air can be minimized or reduced.

During operation, if the unreacted air is condensed in the heat exchanger and then the unreacted air and the unreacted fuel are mixed and separated in the gas-liquid separator, the unreacted air having a relatively low temperature is heated so that the condensed liquid may be gasified. In this case, unreacted air condensation efficiency may be decreased, and a large condenser may be required for receiving liquid in the gasified state.

However, in the present exemplary embodiment, gas and liquid are separated in the first gas-liquid separator 71 and then only the gas is cooled in the first heat exchanger 73. Accordingly, the size of the heat exchanger can be significantly reduced compared to a conventional device cooling liquid and gas both. Further, since two heat exchangers are provided, the size of the first heat exchanger 73 can be minimized.

In addition, during operation the second gas-liquid mixture discharged from the first heat exchanger 73 flows into the second gas-liquid separator 72, and thus, the mixture is separated into gas and liquid. The separated liquid is provided again to the first gas-liquid separator 71, and accordingly, liquid recovery efficiency can be improved. Therefore, the gas-liquid separators 71 and 72 and the heat exchangers 73 and 74 can be reduced in volume, thereby minimizing volume of the entire fuel cell system 200.

In addition, a temperature of fuel flowing into the fuel cell stack 40 can be appropriately controlled using the second heat exchanger 74. That is, since the temperature can be decreased stepwise by providing two heat exchangers 73 and 74, the temperature of the fuel can be further decreased compared to a case of using one heat exchanger, and the size of the heat exchangers 73 and 74 and be further reduced. A total size of the first heat exchanger 73 and the second heat exchanger 74 may be smaller than the size of one convention heat exchanger.

While this disclosure has been described in connection with certain exemplary embodiments, it will be appreciated by those skilled in the art that various modifications and changes may be made without departing from the scope of the present disclosure. The drawings and the detailed description of certain inventive embodiments given so far are only illustrative, and they are only used to describe certain inventive embodiments, but are should not used be considered to limit the meaning or restrict the range of the present invention described in the claims. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Therefore, it will be appreciated to those skilled in the art that various modifications may be made and other equivalent embodiments are available. Accordingly, the actual scope of the present invention must be determined by the spirit of the appended claims, and equivalents thereof.

What is claimed is:

1. A gas-liquid separator, comprising:
a housing including an inflow port configured to receive a gas-liquid mixture, a gas outlet port, and a liquid outlet port;
a first absorbing member disposed to contact the liquid outlet port in an inner space of the housing and configured to absorb liquid in the gas-liquid mixture;
a second absorbing member disposed in the inner space of the housing, the second absorbing member having a smaller volume than a volume of the first absorbing member, the second absorbing member not contacting the first absorbing member;
a liquid pump in fluid communication with the liquid outlet port; and
a gas flow path fluidly connecting the inlet port and the gas outlet port, the gas flow path formed between at least a part of the first absorbing member and at least a part of the second absorbing member.

2. The gas-liquid separator of claim 1, wherein the first absorbing member and the second absorbing member are formed of a hydrophilic and porous material.

3. The gas-liquid separator of claim 2, wherein the gas flow path is directed toward the second absorbing member from the center of the housing.

4. The gas-liquid separator of claim 2, wherein the first absorbing member and the second absorbing member have the same thickness, and wherein the size of the second absorbing member is about 0.01 to about 0.25 times the size of the first absorbing member.

5. The gas-liquid separator of claim 2, wherein the second absorbing member is formed with a constant width along an inner side of the housing, and wherein the second absorbing member partially contacts the inner side of the housing.

6. The gas-liquid separator of claim 5, wherein the width of the second absorbing member is about 1 mm to about 5 mm.

7. The gas-liquid separator of claim 2 further comprising an auxiliary absorbing member contacting both the first absorbing member and the second absorbing member in the housing, and wherein the auxiliary absorbing member has a thickness smaller than that of each of the first and second absorbing members.

8. The gas-liquid separator of claim 1, wherein the housing includes a pair of first side walls facing each other, and a pair of second side walls perpendicular to the pair of first side walls and shorter than the pair of first side walls in length.

9. The gas-liquid separator of claim 8, wherein the inflow port is formed in one of the pair of second side walls and the liquid outlet port is formed in one of the pair of first side walls.

10. The gas-liquid separator of claim 9, wherein the gas outlet port is formed at a first distance from the inlet port in the second side wall where the inlet port is formed, wherein the first absorbing member is formed at a second distance from the entire second side wall where the inlet port is formed, wherein the second absorbing member is formed in parallel with the second side wall, and wherein the inlet port is formed partially contacting the same.

11. The gas-liquid separator of claim 9, wherein the gas outlet port is formed in the other one of the pair of first side walls, wherein the first absorbing member is disposed at a third distance from the entire second side wall where the inlet portion is formed and a part of the first side wall where the gas outlet port is formed, and wherein the second absorbing member is formed in parallel with the second side wall where the inlet port is formed while partially contacting the same.

12. The gas-liquid separator of claim 9, wherein the gas outlet port is formed in the other one of the pair of first side walls, wherein the first absorbing member is disposed at a fourth distance from the entire second side wall where the inlet port is formed and the entire first side wall where the gas outlet port is formed, and wherein the second absorbing member is formed in parallel with the first side wall where the gas outlet port is formed while partially contacting an inner side of the first side wall.

13. The gas-liquid separator of claim 12 further comprising a barrier wall provided at a side of the first absorbing member facing the second side wall where the inlet port is formed.

14. The gas-liquid separator of claim 9, wherein the gas outlet port is formed in the other one of the pair of second side walls, wherein the first absorbing member is disposed at a fifth distance from the entire second side wall where the inlet port is formed, the other first side wall, and wherein a part of the second side wall where the gas outlet port is formed, and wherein the second absorbing member is formed in parallel with the other first side wall while contacting the first side wall.

15. The gas-liquid separator of claim 14 further comprising a barrier wall provided at a side of the first absorbing member and facing the second side wall where the inlet port is formed.

16. A fuel cell system, comprising:
a fuel cell stack configured for generating electrical energy by a reaction between an oxidant and a fuel and discharging a first gas-liquid mixture;
a first gas-liquid separator configured to receive the first gas-liquid mixture from the fuel cell stack and configured to separate the first gas-liquid mixture into a gas and a liquid;
a first heat exchanger configured to receive the gas from the first gas-liquid separator and configured to discharge a second gas-liquid mixture having a temperature lower than that of the first gas-liquid mixture by cooling the gas; and
a second gas-liquid separator configured to receive the second gas-liquid mixture from the first heat exchanger, configured to separate the second gas-liquid mixture into gas and liquid, and configured to supply the separated liquid to the first gas-liquid separator.

17. The fuel cell system of claim 16 further comprising a mixer in fluid communication with the first gas-liquid separator, the mixer configured to dilute a fuel using the liquid supplied from the first gas-liquid separator and configured to supply the diluted fuel to the fuel cell stack, and a second heat exchanger in fluid communication with the mixer and the fuel cell stack, the second heat exchanger configured to decrease a temperature of the fuel supplied to the fuel cell stack.

18. The fuel cell system of claim 16, wherein the second gas-liquid separator comprises:
a housing including an inflow port configured to receive a gas-liquid mixture, a gas outlet port, and a liquid outlet port;
a first absorbing member disposed in an inner space of the housing, the first absorbing member positioned to contact the liquid outlet port and configured to absorb liquid in the gas-liquid mixture received from the inlet port;
a second absorbing member disposed separate from the first absorbing member in the inner space of the housing, the second absorbing member having a smaller volume than a volume of the first absorbing member;
a liquid pump in fluid communication with the liquid outlet port; and
a gas flow path formed between the first absorbing member and the second absorbing member, the gas flow path fluidly connecting the inlet port and the gas outlet port.

19. The fuel cell system of claim 18, wherein the first absorbing member and the second absorbing member are formed of a hydrophilic and porous material.

20. The fuel cell system of claim 19, wherein the gas flow path is directed toward the second absorbing member from the center of the housing.

21. The fuel cell system of claim 19, wherein the first absorbing member and the second absorbing member have the same thickness, and wherein the size of the second absorbing member is about 0.01 to about 0.25 times the size of the first absorbing member.
